(19) United States
(12) Patent Application Publication
(10) Pub. No.: US 2011/0272158 A1
(43) Pub. Date: Nov. 10, 2011

(54) High pressure manifold trailer and methods and systems employing the same

(75) Inventor: Kenneth Gregory Neal, Duncan, OK (US)

(73) Assignee: HALLIBURTON ENERGY SERVICES, INC., Houston, TX (US)

(21) Appl. No.: 12/775,567

(22) Filed: May 7, 2010

(51) Int. Cl. E21B 43/25; B67D 7/72; F17D 1/16; E21B 43/26

(52) U.S. Cl. 166/305.1; 166/90.1; 137/154; 137/14

(57) ABSTRACT

A method of servicing a subterranean formation with a servicing fluid, the method comprising providing a first component of the servicing fluid to a first high-pressure pump at a first pressure, providing a second component of the servicing fluid to a second high-pressure pump at a second pressure, increasing the pressure of the first component of the servicing fluid at the first high-pressure pump to a third pressure, wherein the third pressure is greater than the first pressure, increasing the pressure of the second component of the servicing fluid at the second high-pressure pump to a fourth pressure, wherein the fourth pressure is greater than the second pressure, communicating the first component of the servicing fluid to a high-pressure manifold, communicating the second component of the servicing fluid to the high-pressure manifold, communicating the first component of the servicing fluid from a first high-pressure manifold outlet to a wellhead located at a wellbore, communicating the second component of the servicing fluid from a second high-pressure manifold outlet to the wellhead, and mixing the first component of the servicing fluid and the second component of the servicing fluid at the wellhead to form the servicing fluid.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Hydrocarbon-producing wells often are serviced by in variety of wellbore servicing operations, many of which involve introducing a servicing fluid into a portion of a subterranean formation penetrated by a wellbore. Examples of such servicing operations include a fracturing operation, a hydrajetting operation, an acidizing operation, or the like.

In such wellbore servicing operations it is often desirable to communicate a wellbore servicing fluid to the subterranean formation at a high pressure. Conventionally, the pressure of the wellbore servicing fluid may be increased by a plurality of high-pressure pumping units fed into a high pressure manifold before the servicing fluid is placed in the wellbore. In some instances, the total pumping rate of a servicing fluid may be limited by the size of the flowline through which the servicing fluid flow. However, increasing the size of the flowline may result in a substantial increase in the cost and weight of the manifold system. The maximum weight of over the road trailers is regulated by federal and state agencies. An increase in weight may require removing other equipment on the trailer so that the trailer does not exceed its maximum legal weight. Therefore it has conventionally been difficult to simultaneously attain high total pumping rates and high pressures. Thus, a need exists for a means by which to simultaneously attain high pressures and high total pumping rates.

Also, many wellbore servicing fluids comprise corrosive and/or erosive fluids. Such fluids may damage or degrade equipment employed in wellbore servicing operations, thereby increasing the cost of those operations and necessitating additional time to inspect, repair, or replace wellbore servicing equipment. Thus, a need exists for a means by which to lessen the damage or degradation of the equipment employed in wellbore servicing equipment operations employing corrosive and/or erosive fluids.

### SUMMARY

Disclosed herein is a method of servicing a subterranean formation with a servicing fluid, the method comprising providing a first component of the servicing fluid to a first high-pressure pump at a first pressure, providing a second component of the servicing fluid to a second high-pressure pump at a second pressure, increasing the pressure of the first component of the servicing fluid at the first high-pressure pump to a third pressure, wherein the third pressure is greater than the first pressure, increasing the pressure of the second component of the servicing fluid at the second high-pressure pump to a fourth pressure, wherein the fourth pressure is greater than the second pressure, communicating the first component of the servicing fluid to a high-pressure manifold, communicating the second component of the servicing fluid to the high-pressure manifold, communicating the first component of the servicing fluid from a first high-pressure manifold outlet to a wellhead located at a wellbore, communicating the second component of the servicing fluid from a second high-pressure manifold outlet to the wellhead, and mixing the first component of the servicing fluid and the second component of the servicing fluid at the wellhead to form the servicing fluid.

Also disclosed herein is a method of servicing a subterranean formation with a servicing fluid comprising providing a first component of the servicing fluid, providing a second component of the servicing fluid, increasing the pressure of the first component of the servicing fluid, increasing the pressure of the second component of the servicing fluid, communicating the first component of the servicing fluid via a first route of fluid communication, communicating the second component of the servicing fluid to the via a second route of fluid communication, wherein the first route of fluid communication is in fluid communication with the second route of fluid communication, mixing the first component of the servicing fluid and the second component of the servicing fluid at a wellhead to form the servicing fluid, and communicating the servicing fluid into the subterranean formation at a pressure of at least 10,000 p.s.i. and at a total pumping rate of at least 86 BPM.

Further disclosed herein is a system for servicing a subterranean formation with a servicing fluid comprising a wellbore servicing trailer comprising a high-pressure manifold comprising a first outlet and a second outlet, wherein the first outlet and the second outlet are located toward opposite ends of the manifold, a first high-pressure pump, a second high-pressure pump, a wellhead, a first component of the servicing fluid, wherein the first component of the servicing fluid is pressurized at the first high-pressure pump, communicated from the first high-pressure pump to the manifold, and communicated from the manifold to the wellhead via the first outlet, and a second component of the servicing fluid, wherein the second component of the servicing fluid is pressurized at the second high-pressure pump, communicated from the second high-pressure pump to the manifold, communicated from the manifold to the wellhead via the second outlet, and mixed with the first component of the servicing fluid at the wellhead to form a servicing fluid.

### BRIEF DESCRIPTION OF THE DRAWINGS

FIG. 1A is a schematic overview of an embodiment of wellbore servicing system.

FIG. 1B is a schematic overview of an embodiment of wellbore servicing system.

FIG. 2 is a side view of an embodiment of a high-pressure wellbore servicing trailer.

FIG. 3 is a schematic overview of an embodiment of a split-flow suction header.

FIG. 4A is a schematic overview of an embodiment of a high-pressure, high-pumping-rate manifold.

FIG. 4B is a schematic overview of an embodiment of a high-pressure, high-pumping-rate manifold.

FIG. 4C is an embodiment of a high-pressure, high-pumping-rate manifold, illustrating fluid flow therethrough.

FIG. 5 is a diagram of an embodiment of a wellbore servicing method.

### DETAILED DESCRIPTION

Unless otherwise specified, use of the terms “connect,” “engage,” “couple,” “attach,” or any other like term describing an interaction between elements is not meant to limit the interaction to direct interaction between the elements and may also include indirect interaction between the elements described.

Unless otherwise specified, use of the terms “up,” “upper,” “upward,” “uphole,” “upstream,” or other like terms shall be construed as generally toward the surface of the formation or the surface of a body of water; likewise, use of “down,” “lower,” “downward,” “downhole,” “downstream,” or other like terms shall be construed as generally away from the surface of the formation or the surface of a body of water, regardless of the wellbore orientation. Use of any one or more of the foregoing terms shall not be construed as denoting positions along a perfectly vertical axis.

Unless otherwise specified, use of the term “subterranean formation” shall be construed as encompassing both areas below exposed earth and areas below earth covered by water such as ocean or fresh water.

The operating environment generally comprises a site of a wellbore that penetrates a subterranean formation for the purpose of recovering hydrocarbons, storing hydrocarbons, disposing of carbon dioxide, or the like. The wellbore may be drilled into the subterranean formation using any suitable drilling technique. The wellbore may extend substantially vertically away from the earth's surface over a vertical wellbore portion, or may deviate at any angle from the earth's surface over a deviated or horizontal wellbore portion. In alternative operating environments, portions or substantially all of the wellbore may be vertical, deviated, horizontal, and/or curved.

In an embodiment, a drilling or servicing rig comprising a derrick with a rig floor through which a pipe string (e.g., a drill string, casing string, segmented tubing, coiled tubing, etc.) may be positioned within or partially within the wellbore. The drilling or servicing rig may be conventional and may comprise a motor driven winch and other associated equipment for lowering the pipe string into the wellbore. Alternatively, a mobile workover rig, a wellbore servicing unit (e.g., coiled tubing units), or the like may be used to lower the pipe string into the wellbore. In some instances, a portion of the pipe string may be secured into position within the wellbore in a conventional manner using cement; alternatively, the pipe string may be may be partially cemented in wellbore; alternatively, the pipe string may be uncemented in the wellbore.

The wellbore may terminate at the surface (e.g., the location at which the wellbore penetrates into the subterranean formation) at a wellhead, as will be discussed in greater detail herein below.

It is noted that although some of the figures may exemplify a given operating environment, the principles of the devices, systems, and methods disclosed may be similarly applicable in other operational environments, such as offshore and/or subsea wellbore applications.

The systems, apparatuses, and methods disclosed herein generally relate to a wellbore servicing manifold trailer (WSMT). In an embodiment, the WSMT may be employed to introduce one or more fluids into a wellbore penetrating a subterranean formation during a wellbore servicing operation.

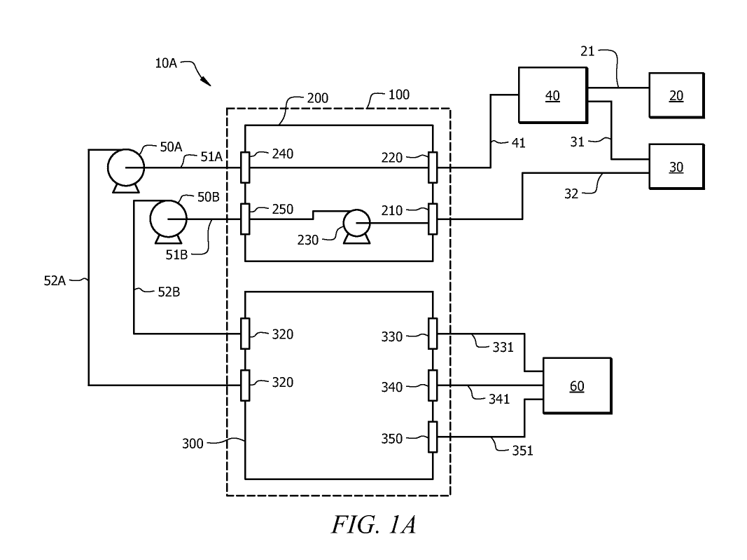

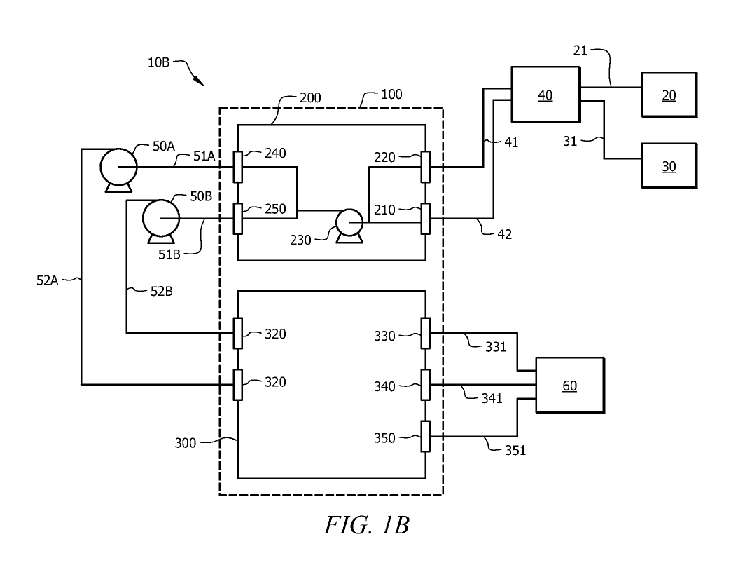

Referring to FIGS. 1A and 1B, a first embodiment of a wellbore servicing system 10A (e.g., a “layout” or “spread”) and a second embodiment of a wellbore servicing system 10B (e.g., a “layout” or “spread”), respectively, are illustrated in an assembled state at a wellbore site. In the embodiments of FIGS. 1A and 1B, the wellbore servicing operation may comprise a fracturing operation. Although FIGS. 1A and 1B pertain to a fracturing operation, a wellbore servicing operation may comprise various other wellbore servicing operations. Examples of such wellbore servicing operations include but are not limited to drilling operations, cementing operations, enhanced oil recovery operations, acidizing operation, carbon dioxide injection operations, or combinations thereof.

Fracturing operations may generally refer to treatments performed to increase the permeability and/or production of a subterranean formation. In a fracturing operation, a fracturing fluid is pumped at high-pressure into a portion of the subterranean formation to be treated, causing one or more fractures to form and/or extend within the formation. Particulate material (e.g., proppant, such as sand, glass beads, etc.) may be mixed with the fracturing fluid to prop open the fractures that form during the operation. Hydraulic fracturing may increase the conductivity through some portion of a formation and thereby increase the production of a natural resource (e.g., oil and/or gas) therefrom. Acidizing operations may refer to a servicing operation wherein an acid is provided within the wellbore to remove near-well formation damage and/or other damaging substances. Acidizing operations may enhance production by increasing the effective wellbore radius. Cementing operations may refer to providing a cement to an annular space between a casing string and a wellbore wall after the casing string has been run-in; to providing cement to a lost circulation zone; to providing cement to a void or a crack in a conduit; providing cement to a void or a crack in a cement sheath disposed in an annular space between a casing string and a wellbore wall; to providing cement to an opening between the cement sheath and the conduit, to providing cement to an existing wellbore from which to push off with directional tools; to providing cement to a well so that it may be abandoned; the like; or combinations thereof. Drilling operations generally include circulation of a drilling fluid within the wellbore, for example to lubricate a drill bit and remove drill cuttings from the wellbore. Finally, a wellbore servicing operation may also include enhancing oil recovery operations such as injecting carbon dioxide into a reservoir of a subterranean formation to increase production therefrom by reducing the viscosity of the natural resources to be produced therefrom (e.g., oil) and providing for miscible or partially miscible displacement of the oil.

In the embodiments of FIGS. 1A and 1B, each of the wellbore servicing operation systems 10A and 10B generally comprises a first and a second storage vessel, 20 and 30 respectively; a blender 40; a WSMT 100, as will be discussed in greater detail herein; a first and second high-pressure pressurizing (HPP) pump, 50A and 50B respectively; and wellhead 60 at the upper terminus (e.g., the uphole end) of a wellbore penetrating a subterranean formation.

In the embodiments of FIGS. 1A and 1B, the wellbore servicing systems 10A and 10B comprise the first storage vessel 20 and the second storage vessel 30. Although the embodiments of FIGS. 1A and 1B illustrate two storage vessels, any suitable number of storage vessels, like the first storage vessel 20 and/or the second storage vessel 30 may be employed. In an embodiment, the first storage vessel 20 and/or the second storage vessel 30 may comprise any suitable storage device, for example a tank, reservoir, hopper, container, or the like. The first and/or second storage vessels 20, 30 may be portable or movable, alternatively, permanent or semi-permanent. The first and/or second storage vessels 20, 30 may be configured to store a given material or substance as will be necessary for a given servicing operation and to provide for delivery of the material or substance stored therein as needed during the wellbore servicing operation. In a non-limiting example, the first and/or second storage vessels 20, 30 may be configured for the storage of a liquid, a solid, a semi-solid, a particulate material, a powder, a suspension, a slurry, a gas, or combinations thereof. In an embodiment, one or more components of a servicing fluid and/or the servicing fluid may be stored in the one or more storage vessels.

In the embodiments of FIGS. 1A and 1B, the wellbore servicing systems 10A and 10B comprise blender 40. The blender 40 may comprise any suitable configuration. The blender 40 may be configured to blend servicing fluid components introduced therein and to discharge the resulting composition (e.g., the servicing fluid) therefrom. For example, the blender 40 may mix solid and fluid components to achieve a consistently-blended fluid. The blender 40 may comprise a tank (e.g., constructed from metal plates, composite materials, or various other materials) and a mixer or agitator that mixes and/or agitates the fluid components within the tank. For example, in an embodiment additives may be pre-blended with a fluid (e.g., water) using a GEL PRO blender (which is a commercially available preblender trailer from Halliburton Energy Services, Inc.) to form a liquid-gel concentrate that may be fed into the blender 40. The mixing conditions of the blender 40, including time period, agitation method, pressure, and temperature, may be chosen by one of ordinary skill in the art with the aid of this disclosure in order to produce a consistent blend having a desirable composition, density, and viscosity. In alternative embodiments, the one or more of the components of the wellbore servicing (WS) fluid may be premixed and/or stored in a storage tank.

In the embodiments of FIGS. 1A and 1B, the wellbore servicing systems 10A and 10B comprise the first HPP pump 50A and the second HPP pump 50B. The first HPP pump 50A and/or the second HPP pump 50B may be configured to increase the pressure of a fluid moving therethrough. Although the wellbore servicing system 10 of FIGS. 1A and 1B illustrate two independently-operating HPP pumps, the number of HPP pumps employed in a given wellbore servicing operation may be chosen by one of ordinary skill in the art with the aid of this disclosure in order to achieve a given parameter (e.g., flow-rate, pressure, etc). The HPP pumps may comprise any suitable type or configuration of pump. Nonlimiting examples of suitable pumps include gear pumps, screw pumps, positive displacement pumps, piston pumps, or combinations thereof. In an embodiment, one or more of the HPP pumps may comprise a HT-400 horizontal triplex positive displacement pump commercially available from Halliburton Energy Services. The operating parameters of the HPP pump 40, including inlet pressure, outlet pressure, revolutions per minute (rpm), inlet flow-rate, outlet flow-rate, or combinations thereof may be adjustable and may be may be chosen by one of ordinary skill in the art with the aid of this disclosure in order to achieve a given parameter (e.g., flow-rate, pressure, etc).

In the embodiments of FIGS. 1A and 1B, the wellbore servicing systems 10A and 10B comprise the wellhead 60. The wellhead 60 may generally comprise various combinations of spools (e.g., a casing spool), interfaces (e.g., a tubing head and/or casing head), valves, hangers (e.g., a casing hanger and/or tubing hanger), assorted adapters (tubing head adapters and/or casing head adapters), various other components as may be generally known to those of skill in the art (e.g., seals, bushings).

In an embodiment, the wellhead 60 may be connected to the pipe string (e.g., a drill string, casing string, segmented tubing, coiled tubing, etc.) which is positioned within the wellbore. In an embodiment, the pipe string may comprise two or more concentrically positioned strings of pipe (e.g., a first pipe string such as a tubing string may be positioned within a second pipe string such as a casing string). A wellbore servicing apparatus configured for one or more wellbore servicing operations may be integrated within the pipe string. The wellbore servicing apparatus may be configured to perform a given servicing operation, for example, fracturing the formation, expanding or extending a fluid path through or into the subterranean formation, producing hydrocarbons from the formation, or other servicing operation. In an embodiment, the wellbore servicing apparatus may comprise one or more ports, apertures, nozzles, jets, windows, or combinations thereof for the communication of fluid from the flowbore of the pipe string to the subterranean formation. In an embodiment, the wellbore servicing apparatus comprises a housing comprising a plurality of housing ports, a sleeve being movable with respect to the housing, the sleeve comprising a plurality of sleeve ports, the plurality of housing ports being selectively alignable with the plurality of sleeve ports to provide a fluid flow path from the wellbore servicing apparatus to the wellbore, the subterranean formation, or combinations thereof. Such a wellbore servicing apparatus is described in greater detail in U.S. application Ser. No. 12/274,193, which is incorporated in its entirety herein by reference. Further, additional downhole tools may be included with or integrated within the wellbore servicing apparatus and/or the pipe string, for example, one or more isolation devices, for example, packers such as swellable packers or mechanical packers. In the embodiments of FIGS. 1A and 1B, the wellhead 60 provides a connection to the pipe sting (a tubing string, the casing string, the annular space located therebetween). As such, a WS fluid introduced at the wellhead 60 may be delivered (e.g., via a downhole wellbore servicing apparatus) to one or more predetermined depths within the well and/or one or more predetermined intervals within the penetrated subterranean formation for the performance of a wellbore servicing operation.

Additionally, in various embodiments, the wellhead 60 may provide pressure control to the wellbore, provide a connection for a “Christmas tree” or the like, provide a means for suspending a tubing string or casing string positioned with the wellbore, allow access to the wellbore for the performance of various wellbore servicing operations (e.g., such as those described herein), or combinations thereof.

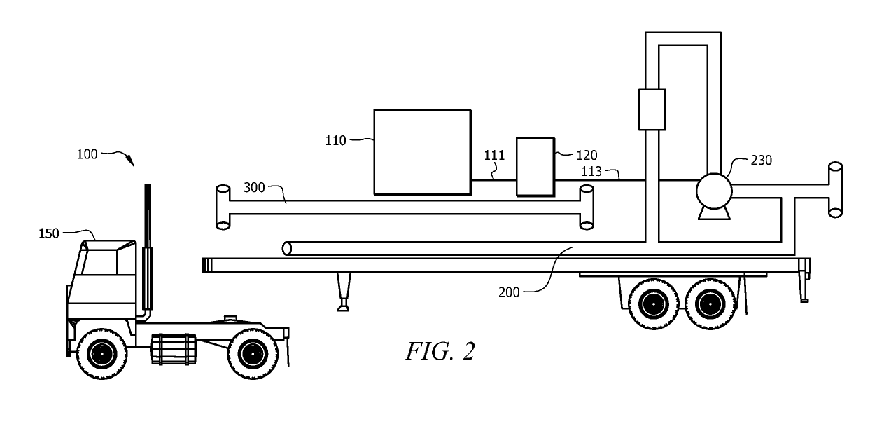

Referring to FIG. 2, the WSMT 100 is shown is greater detail. In various embodiments, the WSMT 100 may provide several advantages over prior art systems. For example, in the embodiments illustrated by FIGS. 1-4, the WSMT 100 may be capable of operation in multiple modes, as will be discussed in greater detail herein. Further, in an embodiment, the WSMT 100 may be capable of providing a WS fluid at a combination of pressure and pumping rate better than the combination of pressure and pumping rate possible in the prior art. In an embodiment, the WSMT disclosed herein may be capable of communicating a WS fluid at a pressure of about 10,000 p.s.i. simultaneous with a pumping rate of about 160 BPM at a velocity of about 35 ft./sec. In another embodiment, the WSMT 100 disclosed herein may be capable of communicating a WS fluid at a pressure of about 15,000 p.s.i. simultaneous with a pumping rate of about 136 BPM at a flow velocity of about 35 ft./sec. In another embodiment, the WSMT 100 disclosed herein may be capable of communicating a WS fluid at a pressure of about 20,000 p.s.i. simultaneous with a pumping rate of about 86 BPM at a flow velocity of about 35 ft./sec.

As illustrated in the embodiment of FIG. 2, the WSMT 100 generally comprises a split-flow suction (SFS) header 200 and a high-pressure, high-pumping-rate (HPHP) manifold 300. In an embodiment, the WSMT may further comprise one or more additional components, as will be described herein. Additionally, the WSMT 100 may be generally configured as any conventional trailer in that the WSMT 100 may be movable, for example as by a truck or tractor 150. In an alternative embodiment, one of skill in the art will appreciate that the components comprising the WSMT 100 may be configured otherwise, for example, the components comprising the WSMT might be located and/or affixed to a platform, a barge, a ship, a skid, a frame, the like, or combinations thereof.

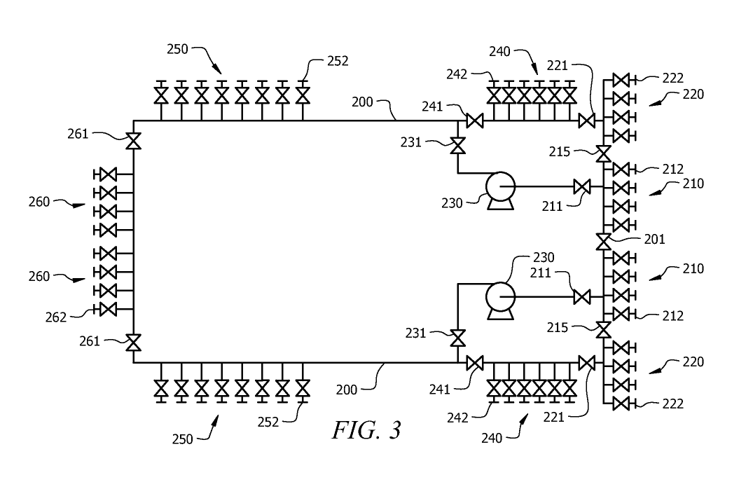

Referring to FIG. 3, an embodiment of the SFS header 200 is illustrated in greater detail. As illustrated in FIG. 1, the SFS header 200 may be configured to receive one or more WS fluids or fluid components (e.g., from the blender 40, the first storage vessel 20 and/or second storage vessels 30) and to distribute the WS fluids or fluid components (e.g., to the first HPP pump 50A and/or the second HPP pump 50B). In the embodiment of FIG. 3, a first and second suction header 200A and 200B, respectively, (cumulatively or individually denoted 200 unless otherwise specified) are shown connected in a parallel configuration. Although the embodiment of FIG. 3 illustrates two suction headers 200 arranged in parallel, one of skill in the art will appreciate that a given WSMT may comprise one, two, three, or more suction headers in various, suitable arrangements.

In an embodiment, the WSMT 100 may be configured such that the first header inflow assembly 210 and/or the second header inflow assembly 220 are located toward the back of the WSMT 100 (e.g., close to the blender 40 or the fluid storage vessels 20 and 30); such that the first header outflow assembly 240 and/or the second header outflow assembly 250 are located along at least one side of the WSMT 100; and/or such that the third header outflow assembly 260 is located toward the front of the WSMT 100.

In the embodiment of FIG. 3, each of the two SFS headers 200 generally comprises a first header inflow assembly 210, a second header inflow assembly 220, a boost pump 230, a first header outflow assembly 240, a second header outflow assembly 250 and a third header outflow assembly 260. In one or more of the embodiments that will be described herein, a given component of one or more of the SFS headers may be in fluid communication with or selective fluid communication with one or more other components of one or more of the SFS headers.

As used herein, “in fluid communication” refers to two or more components connected such that fluid is free to be communicated therebetween; where a first component is in fluid communication with a second component, fluid may be (although, will not necessarily be) communicated between the first component and the second component. For example, two components along a common flowline having no obstructions to flow of fluid therebetween may be said to be in “fluid communication.” Also, as used herein, “in selective fluid communication with” refers to two or more components connected such that fluid may or may not be communicated therebetween; where a first component is in selective fluid communication with a second component, the route may be configured to communicate fluid or to not communicate fluid. For example, two components along a common flowline having a valve or the like therebetween may be said to be in “selective fluid communication” in that, depending upon the configuration of the valve, fluid may or may not be communicated between the first and second component.

In an embodiment, the first header inflow assembly 210 and/or the second header inflow assembly 220 may be configured for connection to one or more flowlines for the communication and distribution of fluids to the WSMT 100. In an embodiment, the first header inflow assembly 210 and/or the second header inflow assembly 220 may generally comprise one or more connector assemblies, 212 and 222, respectively. Although the embodiment of FIG. 3 illustrates each of the first header inflow assembly 210 and the second header inflow assembly 220 comprising four connector assemblies, respectively, any suitable number may be employed. A connector assembly, like connector assemblies 212 or 222, may generally comprise at least one flowline, one or more valves, one or more connectors, or combinations thereof. The one or more valves may comprise any suitable type or configuration of valve. Examples of valves include but are not limited to a butterfly valve, a gate valve, and a ball valve. The valves may be manually actuated (e.g., by an operator) and/or hydraulically, pneumatically, solenoid, or otherwise actuated. The one or more connectors may comprise any suitable type or configuration of connecter. Examples of suitable connectors include but are not limited to threaded connectors, quick-connectors, oilfield hammer unions (e.g., of the kind manufactured by FMC Fluid Control), etc. In an embodiment, a connector assembly, like connector assemblies 212 or 222, comprises a connecter connected to a butterfly valve and the butterfly valve connected to the flowline. The one or more valves may be oriented and/or configured such that fluid may flow into the first header inflow assembly 210 and/or the second header inflow assembly 220. As such, fluid may flow into the first header inflow assembly 210 or the second header inflow assembly 220 via the one or more connectors and/or via the one or more valves.

In an embodiment, the boost pump 230 may comprise any pump suitably configured to increases the pressure of a fluid introduced therein. The boost pump 230 may comprise any suitable type or configuration of pump. Examples of pumps suitably employed as the boost pump 230 include but are not limited to a centrifugal pump, a gear pump, a screw pump, a roller pump, a scroll pump, a piston pump, or combinations thereof. In the embodiment of FIGS. 1A, 1B, 2, and 3, the boost pump comprises a centrifugal pump which may be known to operate efficiently in high-volume operations and/or may allow the pumping rate therefrom to be adjusted. Examples of suitable boost pumps include a 10×8 centrifugal pump commercially available from Mission Sandmaster and/or an API 610 centrifugal pump commercially available from Flowserve Corporation. In an embodiment, the boost pump 230 may have an outlet pressure greater than or equal to about 70 psi, about 80 psi, or about 110 psi and/or the boost pump 230 may have a flow rate of greater than or equal to about 80 BPM, alternatively, about 70 BPM, alternatively about 50 BPM.

In an embodiment, the first header outflow assembly 240 and/or the second header outflow assembly 250 and/or the third header outflow assembly 260 may be configured for connection to one or more flowlines for the communication and distribution of fluids from the WSMT 100. In an embodiment, the first header outflow assembly 240 and/or the second header outflow assembly 250 and/or the third header outflow assembly 260 may generally comprise one or more connector assemblies, 242, 252, and 262 respectively. Although the embodiment of FIG. 3 illustrates each of the first header outflow assembly 240 comprising six connector assemblies, the second header outflow assembly 250 comprising eight connector assemblies, and the third header outflow assembly 260 comprising eight connector assemblies, any suitable number may be employed. A connector assembly, like connector assemblies 242, 252, or 262, may generally comprise at least one flowline, one or more valves, one or more connectors, or combinations thereof. The one or more valves may comprise any suitable type or configuration of valve. Examples of valves include but are not limited to a butterfly valve, a gate valve, and a ball valve. The valves may be manually actuated (e.g., by an operator) and/or hydraulically, pneumatically, solenoid, or otherwise actuated. The one or more connectors may comprise any suitable type or configuration of connecter. The one or more connectors may comprise any suitable type or configuration of connecter. Examples of connectors include but are not limited to threaded connectors, quick-connectors, oilfield hammer unions (e.g., of the type manufactured by FMC Fluid Control), etc. In an embodiment, a connector assembly, like connector assemblies 242, 252, or 262, may comprise a connecter connected to a butterfly valve and the butterfly valve connected to the flowline. The connector assembly may be oriented and/or configured such that fluid may flow out of the first header outflow assembly 240 and/or the second header outflow assembly 250 and/or the third header outflow assembly 260.

Referring to FIG. 3, in an embodiment the first header inflow assembly 210 may be in selective fluid communication with the second header inflow assembly 220, for example via a valve 215 and vice-versa. As such, when valve 215 is configured to communicate fluid (e.g., the valve 215 is “open”), fluid may be communicated from the first header inflow assembly 210 to the second header inflow assembly 220 and/or vice-versa. Alternatively, when valve 215 is configured to not communicate fluid (e.g., valve 215 is “closed”), fluid may not be communicated from the first header inflow assembly 210 to the second header inflow assembly 220 and/or vice-versa.

In an embodiment, the first header inflow assembly 210 may be in selective fluid communication with the boost pump 230, for example via valve 211 and vice-versa. As such, when valve 211 is configured for the communication of fluid (e.g., the valve 211 is “open”), fluid may be communicated from the first header inflow assembly 210 to the boost pump 230 and/or vice-versa. Alternatively, when valve 211 is configured to not communicate fluid (e.g., valve 211 is “closed”), fluid may not be communicated from the first header inflow assembly 210 to the boost pump 230 and/or vice-versa.

In an embodiment, the second header inflow assembly 220 may be in selective fluid communication with the first header outflow assembly 240, for example via valve 221 and vice-versa. As such, when valve 221 is configured for the communication of fluid (e.g., the valve 221 is “open”), fluid may be communicated from the second header inflow assembly 220 to the first header outflow assembly 240 and/or vice-versa. Alternatively, when valve 221 is configured to not communicate fluid (e.g., valve 221 is “closed”), fluid may not be communicated from the second header inflow assembly 220 to the first header outflow assembly 240 and/or vice-versa.

In an embodiment, the first header outflow assembly 240 may be in selective fluid communication with the second header outflow assembly 250, for example via valve 241 and vice-versa. As such, when valve 241 is configured for the communication of fluid (e.g., the valve 241 is “open”), fluid may be communicated from the first header outflow assembly 240 to the second header outflow assembly 250 and/or vice-versa. Alternatively, when valve 241 is configured to not communicate fluid (e.g., valve 241 is “closed”), fluid may not be communicated from the first header outflow assembly 240 to the second header outflow assembly 250 and/or vice-versa.

In an embodiment, the boost pump 230 may be in selective fluid communication with the second header outflow assembly 250, for example via valve 231 and vice-versa. As such, when valve 231 is configured for the communication of fluid (e.g., the valve 231 is “open”), fluid may be communicated from the boost pump 230 to the second header outflow assembly 250 and/or vice-versa. Alternatively, when valve 231 is configured to not communicate fluid (e.g., valve 231 is “closed”), fluid may not be communicated from the boost pump 230 to the second header outflow assembly 250 and/or vice-versa.

In an embodiment, second header outflow assembly 250 may be in selective fluid communication with the third header outflow assembly 260, for example via valve 261 and vice-versa. As such, when valve 261 is configured for the communication of fluid (e.g., the valve 261 is “open”), fluid may be communicated from the second header outflow assembly 250 to the third header outflow assembly 260 and/or vice-versa. Alternatively, when valve 241 is configured to not communicate fluid (e.g., valve 261 is “closed”), fluid may not be communicated from the second header outflow assembly 250 to the third header outflow assembly 260 and/or vice-versa.

Referring again to FIG. 3, in an embodiment where the WSMT 100 comprises two or more SFS headers (e.g., such as SFS header 200), the two or more SFS headers may be in selective fluid communication. As illustrated in the embodiment or FIG. 3, the first and second SFS headers 200 may be in selective fluid communication via valve 201 and/or via the third header outflow assembly 260 and valve(s) 261.

In an embodiment where the WSMT 100 comprises two or more SFS headers, when valve 201 is configured for the communication of fluid (e.g., the valve 201 is “open”), fluid may be communicated from a first SFS header (e.g., such as first SFS header 200A) to a second SFS header (e.g., such as second SFS header 200B) and/or vice-versa. Alternatively, when valve 201 is configured to not communicate fluid (e.g., valve 201 is “closed”), fluid may not be communicated from a first SFS header (e.g., such as first SFS header 200A) to a second SFS header (e.g., such as second SFS header 200B) and/or vice-versa.

Additionally, in an embodiment where the WSMT 100 comprises two or more SFS headers, when valve(s) 261 is/are configured for the communication of fluid (e.g., the valve(s) 261 is/are “open”), fluid may be communicated from a first SFS header (e.g., such as first SFS header 200A) to a second SFS header (e.g., such as second SFS header 200B) and/or vice-versa. Alternatively, when valve 201 is configured to not communicate fluid (e.g., valve 201 is “closed”), fluid may not be communicated from a first SFS header (e.g., such as first SFS header 200A) to a second SFS header (e.g., such as second SFS header 200B) and/or vice-versa.

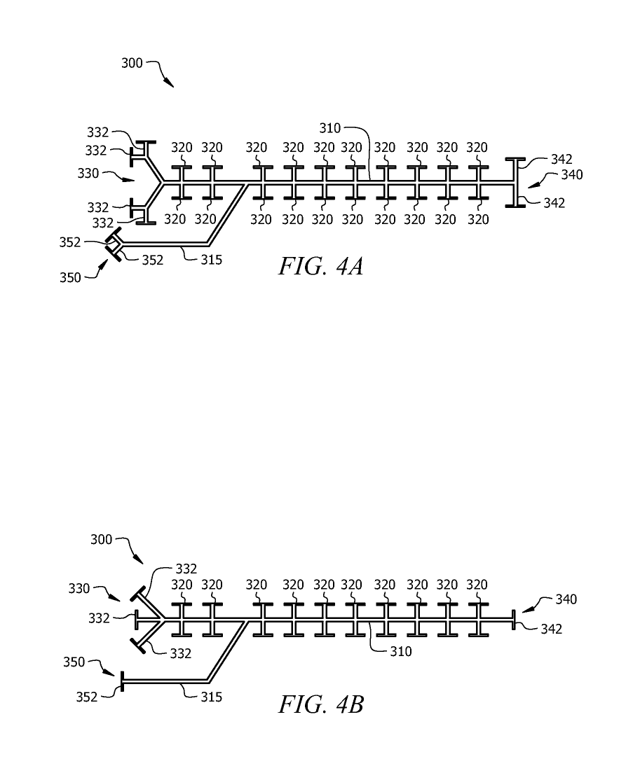

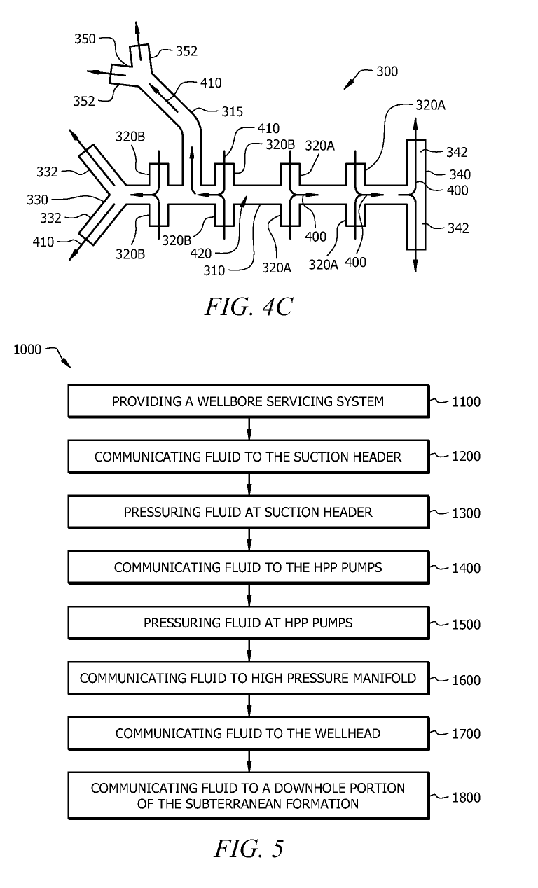

Referring to FIGS. 4A and 4B, embodiments of the HPHP manifold 300 are illustrated in greater detail. In the embodiments of FIGS. 4A and 4B, the HPHP manifold 300 generally comprises a manifold main flowline 310, a manifold auxiliary flowline 315, a plurality of manifold inflow assemblies 320, a first manifold outflow assembly 330, a second manifold outflow assembly 340 and a third manifold outflow assembly 350. In one or more of the embodiments that will be described herein, a given component of the HPHP manifold may be in fluid communication with or selective fluid communication with one or more other components thereof.

In an embodiment, the WSMT 100 may be configured such that the plurality of manifold inflow assemblies 320 are located along at least one side of the WSMT 100; such that the first manifold outflow assembly 330 and/or the third manifold outflow assembly 350 may be located toward the front of the WSMT 100 (e.g., closest to the wellhead 60); and/or such that the second manifold outflow assembly 340 may be located toward the back of the WSMT 100.

In an embodiment, the manifold main flowline 310 and/or the manifold auxiliary flowline 315 generally comprise any suitable conduit through which a fluid may be communicated, nonlimiting examples of which include pipe, tubing or the like. In an embodiment, the manifold main flowline 310 and/or the manifold auxiliary flowline 315 may comprise a metal pipe suitable for the communication of a high-pressure fluid. In an embodiment, the manifold main flowline 310 may comprise an inside diameter of about 5-inches to about 7-inches, alternatively, about 6 inches. In an embodiment, the manifold auxiliary flowline 315 may comprise an inside diameter of about 3-inches to about 5-inches, alternatively, about 4 inches. The manifold main flowline 310 and/or the manifold auxiliary flowline 315 may be rated for at least 10,000 p.s.i., alternatively, at least 15,000 p.s.i., alternatively, at least 20,000 p.s.i. In various embodiments, the manifold main flowline 310 and/or the manifold auxiliary flowline 315 may be capable of a combined flow rate of at least 160 BPM, alternatively, at least 136 BPM, alternatively, at least 86 BPM, at a recommended or desired fluid velocity (e.g., about 35 ft./sec) when outflow at both ends of the manifold main flowline 310 can be utilized.

In an embodiment, each of the manifold inflow assemblies 320 may be configured for connection to one or more flowlines for the communication and distribution of fluids to the WSMT 100. The embodiments of FIGS. 4A, 4B, and 4C illustrate a HPHP manifold 300 comprising various numbers of manifold inflow assemblies 320, and any suitable number may be used. A manifold inflow assembly, like manifold inflow assemblies 320, may comprise at least one flowline, one or more connectors, optionally, one or more valves, or combinations thereof. In embodiments where a manifold inflow assembly 320 comprises one or more valves, the one or more valves may comprise any suitable type or configuration of valve. Examples of valves include but are not limited to a gate valve, a ball valve, and/or a check valve. The valves may be manually actuated (e.g., by an operator) and/or hydraulically, pneumatically, solenoid, or otherwise actuated. The one or more connectors may comprise any suitable type or configuration of connecter. Examples of connectors include but are not limited to threaded connectors, quick-connectors, oilfield hammer unions (e.g., of the type manufactured by FMC Fluid Control), etc. In an embodiment, a manifold inflow assembly, like manifold inflow assemblies 320, comprises a connecter connected to a check valve and check valve connected to the flowline. The one or more check valves may be oriented and/or configured such that fluid may flow into the HPHP manifold 300. As such, fluid may flow into the HPHP manifold 300 via the one or more manifold inflow assemblies 320.

In an embodiment, the first manifold outflow assembly 330 and/or the second manifold outflow assembly 340 and/or the third manifold outflow assembly 350 may be configured for connection to one or more flowlines for the communication and distribution of fluids from the WSMT 100. In an embodiment, the first manifold outflow assembly 330 and/or the second manifold outflow assembly 340 and/or the third manifold outflow assembly 350 may generally comprise one or more connector assemblies, 332, 342, and 352 respectively. The embodiment of FIGS. 4A-4C illustrate each of the first manifold outflow assembly 330 and/or the second manifold outflow assembly 340 and/or the third manifold outflow assembly 350 comprising various numbers of connector assemblies, any suitable number may be used. A connector assembly, like connector assemblies 332, 342, or 352, may generally comprise at least one flowline, one or more valves, one or more connectors, or combinations thereof. The one or more valves may comprise any suitable type or configuration of valve. Examples of suitable valves include but are not limited to a gate valve and/or a check valve. The valves may be manually actuated (e.g., by an operator) and/or hydraulically, pneumatically, solenoid, or otherwise actuated. The one or more connectors may comprise any suitable type or configuration of connecter. Examples of connectors include but are not limited to threaded connectors, quick-connectors, oilfield hammer unions (e.g., of the type manufactured by FMC Fluid Control), etc. In an embodiment, a connector assembly, like connector assemblies 332, 342, or 352, comprises a connecter connected to a check valve and the check valve connected to the flowline. In an alternative embodiment, a connector assembly, like connector assemblies 332, 342, or 352, comprises a connecter connected to a flowline with no valve attached thereto. The one or more check valves may be oriented and/or configured such that fluid may flow out of the first manifold outflow assembly 330 and/or the second manifold outflow assembly 340 and/or the third manifold outflow assembly 350. As such, fluid may flow out of the first manifold outflow assembly 330 and/or the second manifold outflow assembly 340 and/or the third manifold outflow assembly 350 via the one or more connectors and/or via the one or more check valves.

In an embodiment, each of the manifold inflow assemblies 320 may be connected to and in fluid communication with the manifold main flowline 310 and vice-versa. As such, fluid may be communicated from each of the manifold inflow assemblies 320 to the manifold main flowline 310 and/or vice-versa.

In an embodiment, the manifold main flowline 310 may be connected to and in fluid communication with the first manifold outflow assembly 330 and/or the second manifold outflow assembly 340 and/or the third manifold outflow assembly 350 and vice-versa. As such, fluid may be communicated from the manifold main flowline 310 to the first manifold outflow assembly 330 and/or the second manifold outflow assembly 340 and/or vice-versa. As shown in FIGS. 4A and 4B, in an embodiment the first manifold outflow assembly 330 may be in fluid communication with the manifold main flowline 310 at a first end of the manifold main flowline 310 and the second manifold outflow assembly 340 may be in fluid communication with the manifold main flowline 310 at the opposite end of the manifold main flowline 310 (e.g., the first manifold outflow assembly 330 may be connected to the manifold main flowline 310 at the end toward the front of the WSMT 100 and the second manifold outflow assembly 340 may be connected at the end toward the rear of the trailer).

In an embodiment, the manifold main flowline 310 may be connected to and in fluid communication with the manifold auxiliary flowline 315, and the manifold auxiliary flowline 315 may be connected to and in fluid communication with the third manifold outflow assembly 350. As such, fluid may be communicated from the manifold main flowline 310 to the auxiliary flowline 315 to the third manifold outflow assembly 350 and/or vice-versa. As shown in FIGS. 4A and 4B, in an embodiment the manifold auxiliary flowline 315 may be connected to the manifold main flowline 310 at a position along the manifold main flowline 310. The manifold auxiliary flowline 315 may be connected to the manifold main flowline 310 nearer the connection to the first manifold outflow assembly 330, alternatively, nearer the connection to the second manifold outflow assembly 340, alternatively, about the same distance (i.e., equidistant) along the manifold main flowline 310 from the first manifold outflow assembly 330 and the second manifold outflow assembly 340.

In various embodiments, the HPHP manifold 300 may be configured to communicate a WS fluid to the wellhead 60 at a given combination of pressure and pumping rate. As may be appreciated, various configurations of the HPHP manifold 300 may be capable of communicating the WS fluid at differing combinations of pressure and pumping rate.

For example, in the embodiment of FIG. 4A, the HPHP manifold 300 is configured to communicate a WS fluid to the wellbore 60 at a pressure of about 15,000 p.s.i. simultaneous with a pumping rate of about 136 BPM at the recommended velocity (e.g., about 35 ft./sec.). In the embodiment of FIG. 4A, the manifold main flowline 310 comprises a 6-inch flowline (e.g., 6-inch Big Inch®) capable of a pumping rate of about 72 BPM. The first manifold outflow assembly 330 comprises four 3-inch flowlines (e.g., 1502 Line), each being capable of a pumping rate of about 18 BPM for a combined pumping rate of about 72 BPM via the first manifold outflow assembly 330. The second manifold outflow assembly 340 comprises two 3-inch flowlines (e.g., 1502 Line), each being capable of a pumping rate of about 18 BPM for a combined pumping rate of about 36 BPM via the second manifold outflow assembly 340. The manifold auxiliary flowline 315 comprises a 4-inch flowline (e.g., 4-inch Big Inch®) being capable of 32 BPM. The third manifold outflow assembly 350, which receives fluid from the manifold auxiliary flowline 315, comprises two 3-inch flowlines (e.g., 1502 Line), each being capable of 18 BPM for a potential pumping rate of about 32 BPM (e.g., because the pumping rate is limited by the manifold auxiliary flowline 315) via the third manifold outflow assembly 340. As such, in the embodiment of FIG. 4A, the HPHP manifold is configured to communicate a WS fluid to the wellbore 60 at a pressure of about 15,000 p.s.i. simultaneous with a pumping rate of about 136 BPM.

Also for example, in the embodiment of FIG. 4B, the HPHP manifold 300 is configured to communicate a WS fluid to the wellbore 60 at a pressure of about 10,000 p.s.i. simultaneous with a pumping rate of about 160 BPM at the recommended velocity (e.g., about 35 ft./sec.). In the embodiment of FIG. 4B, the manifold main flowline 310 comprises 7-inch flowline (e.g., 7-inch Big Inch®) capable of a pumping rate of about 98 BPM. The first manifold outflow assembly 330 comprises three 4-inch flowlines (e.g., 4 inch 10,000 PSI Line with FIG. 1002 oilfield hammer union connections), each being capable of a pumping rate of about 32 BPM for a combined pumping rate of about 96 BPM via the first manifold outflow assembly 330. The second manifold outflow assembly 340 comprises one 4-inch flowline (e.g., 4 inch 10,000 PSI Line with FIG. 1002 oilfield hammer union connections) being capable of a pumping rate of about 32 BPM via the second manifold outflow assembly 340. The manifold auxiliary flowline 315 comprises a 4-inch flowline (e.g., 4 inch line with 4 inch Big Inch® hub connections) being capable of 32 BPM. The third manifold outflow assembly 350, which receives fluid from the manifold auxiliary flowline 315 comprises one 4-inch flowline (e.g., 4 inch 10,000 PSI Lines with FIG. 1002 oilfield hammer union connections) being capable of 32 BPM via the third manifold outflow assembly 340. As such, in the embodiment of FIG. 4B, the HPHP manifold is configured to communicate a WS fluid to the wellbore 60 at a pressure of about 10,000 p.s.i. simultaneous with a pumping rate of about 160 BPM.

Referring again to FIG. 2, in an embodiment the WSMT 100 further comprises a power source 110, examples of which include but are not limited to a diesel engine or gasoline engine. An example of suitable diesel engine includes a 520 horsepower C13 commercially available from Caterpillar Global Petroleum. In an alternative embodiment, a WSMT like WSMT 100 may derive power from an external source, examples of which include but are not limited to a diesel or gasoline engine, a source of electricity, a source of hydraulic power, or combinations thereof.

In an embodiment the WSMT 100 further comprises a hydraulic control system 120 which may be configured to transfer power from the power source 110 to the boost pump 230. In an embodiment, a suitable hydraulic control system 120 includes a hydrostatic transmission comprising a variable displacement axial piston hydraulic pump with electric displacement control (for example, as commercially available from Sundstrand), a fixed displacement hydraulic motor (for example, as commercially available from Volvo Hydraulics), a hydraulic gear pump (for example, as commercially available from Barnes), various hydraulic components (e.g., hydraulic fluid, a hydraulic fluid reservoir, a hydraulic fluid cooler, and hydraulic hoses and fittings), a pressure transducer to monitor pressure, and a computer encoding suitable software. In an embodiment, the variable displacement axial piston hydraulic pump may receive rotational power from the power source 110 via drive shaft 111 and pressurize hydraulic fluid line 113. The pressurized hydraulic fluid may be communicated to the fixed displacement hydraulic motor which may be operably connected to the boost pump 230, thereby imparting rotational power to the boost pump 230. The computer may communicate an electronic signal to the variable displacement axial piston hydraulic pump to control the amount of hydraulic fluid pumped, thus controlling flow rate of hydraulic fluid to the fixed displacement motor and, thus, the pump rate of the boost pump 230. The hydraulic control system 230 may also be used to actuate and/or control one or more other components of the WSMT 100; for example, one of skill in the art will appreciate that the hydraulic system may be employed to control one or more of the various valves.

The WSMT 100 may further comprise one or more lights for illuminating all or a portion of an area proximate to the trailer. An example of a suitable light includes but is not limited to a 150-Watt Xenon light. The power source 110 may provide power to illuminate the lights, for example, via a suitable electric generator and electrical connections (e.g., electric wiring and switches). The power source 110 may additionally be used to power other equipment and/or components.

Referring again to FIGS. 1A and 1B, in embodiments the wellbore servicing systems 10A and 10B comprise a plurality of flowlines between the various components thereof. In an embodiment, a given flowline between the various components of wellbore servicing systems 10A and 10B may be chosen by one of skill in the art with the aid of this disclosure to suitably convey the serving fluid and/or a given component thereof. In an embodiment, the various flowlines may comprise any suitable conduit through which a fluid may be communicated, nonlimiting examples of which include pipe, tubing, or the like. The various flowlines may be connected via a suitable connection as may be chosen by one of skill in the art with the aid of this disclosure, nonlimiting examples of which include one or more flanges, collars, couplers, threaded joints, welded joints, the like, or combinations thereof. Additionally, in an embodiment, one or more of these flowlines may include various configurations of pipe tees, elbows, the like, or combinations thereof. It is to be understood that although a given route a fluid communication between two or more of the various components of wellbore servicing systems 10A and 10B may be illustrated as comprising only a single flowline, one or more flowlines may be employed in series and/or in parallel to provide a route of fluid communication. In various embodiments, one or more of the flowlines may be suitable for the high-pressure communication of a fluid. For example, in embodiments a flowline may be rated for at least 10,000 p.s.i., alternatively, at least 15,000 p.s.i., alternatively, at least 20,000 p.s.i. In various embodiments, one or more of the flowlines may suitable for the communication of fluid at a given pumping rate. For example, in embodiments a flowline may be capable of a pumping rate of at least 32 barrels per minute (BPM), alternatively, at least 50 BPM, alternatively, at least 72 BPM, alternatively, 100 BPM. One of skill in the art viewing this disclosure will recognize that a given flowline may be selected to meet one or parameters as may be necessary for the communication of fluid between two or more components of the wellbore servicing system 10.

For example, in the embodiments of FIGS. 1A and 1B, fluid communication between the first storage vessel 20 and the blender 40 may be via flowline 21 and communication between the second storage vessel 30 and the blender 40 may be via flowline 31. In the embodiment of FIG. 1A, fluid communication between the second storage vessel 30 and the WSMT 100, particularly the first header inflow assembly 210, may be via flowline 32 and fluid communication between the blender 40 and WSMT 100, particularly the second header inflow assembly 220, may be via flowline 41. Alternatively, in the embodiment of FIG. 1B fluid communication between the blender 40 and WSMT 100, particularly the second header inflow assembly 220 and the first header inflow assembly 210, may be via flowlines 41 and 42, respectively. Fluid communication between the WSMT 100 and the HPP pumps, particularly between the first header outflow assembly 240 and the first HPP pump 50A and between the second header outflow assembly 250 and the second HPP pump 50B may be via flowline 51A and flowline 51B, respectively. Fluid communication between the HPP pumps and the WSMT 100, particularly between first HPP pump 50A and a first one of the manifold inflow assemblies 320 and between the second HPP pump 50B and a second one of the manifold inflow assemblies 320 may be via flowline 52A and flowline 52B, respectively. Fluid communication between the WSMT 100 and the wellhead 60, particularly between the first manifold outflow assembly 330 and/or the second manifold outflow assembly 340 and/or the third manifold outflow assembly 350 and the wellhead 60, may be via flowline 331, flowline 341 and/or 351, respectively.

The wellbore servicing system 10 and WSMT 100 having been described, wellbore servicing operations employing the wellbore servicing system 10 and the WSMT 100 are now described.

Referring to FIG. 5, an embodiment of a wellbore servicing method 1000 is depicted. In the embodiment of FIG. 5, the wellbore servicing method generally comprises providing a wellbore servicing system 1100; communicating fluid to the suction header 1200; pressurizing fluid at the suction header 1300; communicating fluid to the HPP pumps 1400; pressurizing fluid at the HPP pumps 1500; communicating fluid to the high-pressure manifold 1600; communicating fluid to the wellhead 1700; and communicating fluid to a downhole portion of the subterranean formation 1800.

In an embodiment, providing a suitable wellbore servicing system 1100 may comprise transporting one or more components of a wellbore servicing system (e.g., wellbore servicing system 10A or 10B) as described herein to a the site of a wellbore to be serviced, suitable wellbore servicing systems having been illustrated and described above with reference to FIGS. 1A and 1B. For example, the WSMT 100 may be attached to transported to the site via truck or tractor 150. Similarly, in an embodiment one or more of the other components of the wellbore servicing system 10 may be transported to the site (e.g., via a truck or tractor towing a trailer or the like).

In an embodiment, providing a suitable wellbore servicing system 1100 may comprise assembling and/or connecting the system components (e.g., such as those described herein) to yield a wellbore servicing system like wellbore servicing system 10.

In an embodiment, providing a suitable wellbore servicing system 1100 may comprise storing/providing the components of the WS fluid (e.g., in the first storage vessel 20 and/or the second storage vessel 30). For example, in an embodiment where the servicing operation comprises a fracturing operation the WS fluid may comprise a fracturing fluid. In an embodiment, such a fracturing fluid may comprise two or more fracturing fluid components. As referred to herein, WS components refer to two or more components that, when mixed in a desirable proportion, yield the WS fluid. In an embodiment, a suitable fracturing fluid may be formed by mixing together in a desirable ratio a first fracturing fluid component (e.g., a particulate material, a proppant, a friction reducer, a concentrated slurry, an acid, a servicing fluid additive, the like, or combinations thereof) and a second servicing fluid component (e.g., water, various oleaginous fluids, liquid carbon dioxide, or combinations thereof).

In such an embodiment, the first storage vessel 20 may store the first fracturing fluid component (e.g., a particulate material, a proppant, a friction reducer, a concentrated slurry, an acid, a servicing fluid additive, the like, or combinations thereof) and the second storage vessel 30 may store the second servicing fluid component (e.g., water, various oleaginous fluids, or combinations thereof). In an embodiment, the second fracturing fluid component may comprise water. In various embodiments, the water may be potable, non-potable, untreated, partially treated, or treated water. In an embodiment, the water may be produced water that has been extracted from the wellbore while producing hydrocarbons form the wellbore. The produced water may comprise dissolved and/or entrained organic materials, salts, minerals, paraffins, aromatics, resins, asphaltenes, and/or other natural or synthetic constituents that are displaced from a hydrocarbon formation during the production of the hydrocarbons. In an embodiment, the water may be flowback water that has previously been introduced into the wellbore during a wellbore servicing operation. The flowback water may comprise some hydrocarbons, gelling agents, friction reducers, surfactants and/or remnants of WS fluids previously introduced into the wellbore during wellbore servicing operations. The water may further comprise local surface water contained in natural and/or manmade water features (such as ditches, ponds, rivers, lakes, oceans, etc.). Still further, the water may comprise water stored in local or remote containers. The water may be water that originated from near the wellbore and/or may be water that has been transported to an area near the wellbore from any distance. In some embodiments, the water may comprise any combination of produced water, flowback water, local surface water, and/or container stored water. In an embodiment, a third, fourth, fifth, etcetera, storage vessel may store one or more additional servicing fluid components.

In an embodiment, providing a suitable wellbore servicing system 1100 may comprise configuring the WSMT 100 to operate in a selected or desirable mode. As explained above, the WSMT 100 is capable of configuration for operation in at least one of multiple modes. For example, as illustrated in the embodiment of FIG. 1A the WSMT 100 may be configured to operate in a “split-flow” mode, as will be described herein in greater detail. Referring to FIG. 3, in an embodiment where the WSMT is configured for operation in the split-flow mode, valve 201, valves 215, valves 241, and valves 261 may be closed (i.e., thereby inhibiting or preventing the passage of fluid therethrough) while valves 211, valves 221, and valves 231 may be open (i.e., thereby permitting the passage of fluid therethrough).

Alternatively, as illustrated in the embodiment of FIG. 1B the WSMT 100 may be configured to operate in a boosted high-rate mode, as will be described herein in greater detail. Referring again to FIG. 3, in an embodiment where the WSMT 100 is configured for operation in the boosted high-rate mode, valve 201, valves 221, and valves 261 may be closed (i.e., thereby inhibiting or preventing the passage of fluid therethrough) while valves 211, valves 215, valves 231, valves 241 may be open (i.e., thereby permitting the passage of fluid therethrough).

Alternatively, in embodiments the WSMT 100 may be configured (or configurable) to bypass one or more components of the WSMT 100 and/or of wellbore servicing systems 10A and 10B, as will be described herein in greater detail.

In an embodiment, communicating fluid to the suction header 1200 (e.g., SFS header 200) may comprise communicating a first WS fluid component and a second WS fluid component to the SFS header 200. For example, in the embodiment of FIG. 1A where the WSMT 100 operates in split-flow mode, the first WS fluid component may comprise concentrated slurry and the second WS fluid component may comprise water; when the concentrated slurry and the water are mixed in the appropriate proportion, the WS fluid is formed. In such an embodiment, the concentrated slurry may be formed by introducing into the blender 40 water (e.g., via flowline 31) proppant, (e.g., via flowline 21) and/or additional additives and mixing to achieve a desirably consistent mixture. The concentrated slurry formed in the blender 40 may be expelled (e.g., flow under pressure) therefrom and communicated via flowline 41 to the second header inflow assembly 220. The water may be communicated via flowline 32 to the first header inflow assembly 210.

Alternatively, in an embodiment, communicating fluid to the suction header 1200 may comprise communicating a WS fluid to the SFS header 200. For example, in the embodiment of FIG. 1B where the WSMT 100 operates in boosted high-rate mode, the components of the WS fluid may be formed by introducing into the blender 40 one or more of water (e.g., via flowline 31) proppant, (e.g., via flowline 32) and/or additional additives and mixing to achieve a desirably consistent mixture. The WS fluid formed in the blender 40 may be expelled (e.g., flow under pressure) therefrom via flowlines 41 and 42 to the first header inflow assembly 210 and to the second header inflow assembly 220.

In an embodiment, pressurizing fluid at the suction header 1300 comprises pressurizing a component of the WS fluid. For example, in the embodiment of FIG. 1A where the WSMT 100 operates in split-flow mode, the second WS fluid component (e.g., water) may be communicated from the second storage vessel 30 to the first header inflow assembly 210 via flowline 32 and from the first header inflow assembly 210 to the boost pump 230 via valve 211 (which is open). In an embodiment, the water may be drawn into the boost pump 230 via a negative pressure (e.g., the boost pump 230 may develop a suction pressure). The boost pump 230 may increase the pressure of (e.g., “boost”) the water.

Alternatively, in an embodiment pressurizing fluid at the suction header 1300 comprises pressurizing the WS fluid. For example, in the embodiment of FIG. 1B where the WSMT 100 operates in boosted high-rate mode, the WS fluid may be communicated from the blender to the first header inflow assembly 210, the second header inflow assembly 220, or both and from the first header inflow assembly 210 and/or second header inflow assembly 220 (e.g., via the first header inflow assembly 210) to the boost pump 230 via valve 211.

Alternatively, in an embodiment the WSMT 100 may be configured to bypass the boost pump 230. For example, in an embodiment where the boost pump 230 becomes inoperable during the course of a servicing operation, it may be desirable to divert fluid away from the inoperable boost pump 230 without ceasing the servicing operation. In an embodiment, fluid may be diverted during the servicing operation by opening and/or closing various valves. For example, referring to FIG. 3, in an embodiment where an operator wishes to divert fluid away from a boost pump like boost pump 230, the operator may close valves 201, 211, 231, and 261 and open valves 215, 221, and 241. In so doing, the operator may divert fluid from the boost pump and route all fluid from the first header inflow assembly 210 and/or the second header inflow assembly 220 to the first header outflow assembly 240 and/or the second header outflow assembly 250.

In an embodiment, communicating fluid to the HPP pumps 1400 may comprise communicating a first WS fluid component to a first HPP pump and a second WS fluid component to a second HPP pump. Referring to FIGS. 1A and 3, in an embodiment where the WSMT 100 operates in split-flow mode, the first WS fluid component (e.g., the concentrated slurry) may be communicated from the blender 40 to the second header inflow assembly 220 via flowline 41, from the second header inflow assembly 220 to the first header outflow assembly 240 via valve 221, and from the first header outflow assembly 240 to the first HPP pump 50A via flowline 51A. The concentrated slurry may be expelled from the blender 40 under pressure and, as such, may flow through the second header inflow assembly 220, the first header outflow assembly 240, as well as the various flowlines and valves to the first HPP pump 50A. The second WS fluid component (e.g., water) may be communicated from the boost pump 230 to the second header outflow assembly 250 via valve 231 and from the second header outflow assembly 250 to the second HPP pump 50B via flowline 51B. The water may be expelled from the boost pump 230 under pressure and, as such, may flow through the second header outflow assembly 250, as well as the various flowlines and valves, to the second HPP pump 50B.

Alternatively, in an embodiment, communicating fluid to the HPP pumps 1400 may comprise communicating a WS fluid to one or more HPP pumps, 50A and/or 50B. Referring to FIGS. 1B and 3, in an embodiment where the WSMT 100 operates in the boosted high-rate mode, the WS fluid may be communicated from the boost pump 230 to the first header outflow assembly 240 and the second header outflow assembly 250 via valves 231 and 241, and from the first header outflow assembly 240 and second header outflow assembly 250 to the to the first HPP pump 50A and the second HPP pump 50B via flowlines 51A and 51B, respectively.

In an embodiment, pressurizing fluid at the HPP pumps 1500 may comprise increasing the pressure of a first WS fluid component and increasing the pressure of a second WS fluid component. Referring to FIG. 1A, in an embodiment where the WSMT 100 operates in split-flow mode, the first WS fluid component (e.g., the concentrated slurry) may be pressurized by the first HPP pump 50A and the second WS fluid component (e.g., the water) may be pressurized by the second HPP pump 50B.

Alternatively, in an embodiment pressurizing fluid at the HPP pumps 1500 may comprise increasing the pressure of a WS fluid. Referring to FIG. 1B, in an embodiment where the WSMT 100 operates in the boosted high-rate mode, the WS fluid may be pressurized by the first HPP pump 50A and/or the second HPP pump 50B.

In an embodiment, communicating fluid to the manifold 1600 (such as HPHP manifold 300) may comprise communicating a first WS fluid component to a first of the manifold inflow assemblies 320 and a second WS fluid component to a second of the manifold inflow assemblies 320. Referring to FIGS. 1A, 4A, and 4B, in an embodiment where the WSMT 100 operates in split-flow mode, the first WS fluid component (e.g., the concentrated slurry) may be communicated from the first HPP pump 50A to a first of the manifold inflow assemblies 320 via flowline 52A and the second WS fluid component (e.g., the water) may be communicated from the second HPP pump 50B to a second of the manifold inflow assemblies 320 via flowline 52B. In an embodiment, the concentrated slurry may be communicated to one of the manifold inflow assemblies 320 that is closer to the second manifold outflow assembly 340 than the one of the manifold inflow assemblies 320 to which the water is communicated. Similarly, in an embodiment, the water may be communicated to one of the manifold inflow assemblies 320 that is closer to the first manifold outflow assembly 330 than the one of the manifold inflow assemblies 320 to which the concentrated slurry is communicated. The HPP pumps, 50A and 50B, may increase the pressure of the concentrated slurry and of the water. The concentrated slurry may be expelled from the first HPP pump 50A under pressure and, as such, may flow through the various flowlines and valves to the first of the manifold inflow assemblies 320. Similarly, the water may be expelled from the second HPP pump 50B under pressure and, as such, may flow through the various flowlines and valves to the second of the manifold inflow assemblies 320.

Alternatively, in an embodiment communicating fluid to the manifold 1600 (such as HPHP manifold 300) may comprise communicating the WS fluid to one or more of the manifold inflow assemblies 320. Referring to FIG. 1B, in an embodiment where the WSMT 100 operates in the boosted high-rate mode, the WS fluid may be communicated from the first and second HPP pumps, 50A and 50B, to at least two of the manifold inflow assemblies 320. The concentrated slurry may be expelled from the first and second HPP pumps 50A and 50B under pressure and, as such, may flow through the various flowlines and valves to the manifold inflow assemblies 320.

In an embodiment, communicating fluid to the wellhead 1700 may comprise communicating a first WS fluid component a second WS fluid component to the wellhead 60. Referring to FIGS. 1A, 4A, and 4B, in an embodiment where the WSMT 100 operates in split-flow mode, the first WS fluid component (e.g., the concentrated slurry) may be communicated from the first of the manifold inflow assemblies 320 to second manifold outflow assembly 340 via the manifold main flowline 310 and from the second manifold outflow assembly 340 to the wellhead 60 via flowline 341. The second WS fluid component (e.g., the water) may be communicated from the second of the manifold inflow assemblies 320 to first manifold outflow assembly 330 and/or the third manifold outflow assembly 350 via the manifold main flowline 310 and/or the manifold auxiliary flowline 315, and from the first manifold outflow assembly 330 and/or the third manifold outflow assembly 350 to the wellhead 60 via flowlines 331 and 351, respectively. In an embodiment, although the first WS fluid component (e.g., concentrated slurry) and the second WS fluid component (e.g., water) may both, simultaneously, flow via the manifold main flowline 310, the concentrated slurry and water may remain substantially unmixed upon flowing through the manifold main flowline 310. As used herein, “substantially unmixed” means that the less than about 10%, alternatively, less than about 5%, alternatively, less than about 1%, by volume of the two WS fluid components is intermingled. In an embodiment, a “no-flow” or stagnant zone may exist within the manifold main flowline 310. In an embodiment, the total flow-rate in either direction in such a no-flow zone may be less than about 5 BPM, alternatively, less than about 3 BPM, alternatively, less than about 1 BPM.

For example, referring to FIG. 4C, an embodiment of the various fluid flows via the HPHP manifold 300 is illustrated. In the embodiment of FIG. 4C, the concentrated slurry (represented by flow arrow 400) enters the HPHP manifold 300 via one or more first manifold inflow assemblies 320A. The concentrated slurry 400 flows via the manifold main flowline 310 to the second manifold outflow assembly 340 and out of the HPHP manifold 300. Also in the embodiment of FIG. 4C, the water (represented by flow arrow 410) enters the HPHP manifold 300 via one or more second manifold inflow assemblies 320B. The water 410 flows via the manifold main flowline 310 to the first and third manifold outflow assemblies, 330 and 350, and out of the HPHP manifold 300. Thus, in such an embodiment even though the water and the concentrated slurry flow via the manifold main flowline 310, little or no mixing or intermingling of the concentrated slurry and the water occurs. Also shown in FIG. 4C, a no-flow zone 420 exists, approximately at the interface between the water and the concentrated slurry.

Referring to FIGS. 1A, 4A, and 4B, in an embodiment where the WSMT 100 operates in split-flow mode, the first WS fluid component (e.g., the concentrated slurry) may be mixed with the second WS fluid component (e.g., the water) at the wellhead 60. In such an embodiment, upon mixing the first WS fluid component and the second WS fluid component, a WS fluid may result. The character and/or properties of such a WS fluid may be adjusted in real-time (i.e., at the point in time where the WS fluid enters the wellhead) by adjusting the relative flow-rates, pressures, and amounts of the first and second WS fluid components. In an embodiment, various effects may contribute to the mixing of the first WS fluid component and the second WS fluid component at the wellhead 60 (e.g., turbulent forces, Coriolis effects, etc).

Alternatively, in an embodiment, communicating fluid to the wellhead 1700 may comprise communicating a WS fluid to the wellhead 60. Referring to FIGS. 1B and 3, in an embodiment where the WSMT 100 operates in the boosted high-rate mode, the WS fluid may be communicated from one or more of the manifold inflow assemblies 320 to the first and second manifold outflow assemblies 330 and 340 via the manifold main flowline 310 and to the third manifold outflow assembly 350 via the manifold auxiliary flowline 315. The WS fluid may be communicated from the first, second, and third manifold outflow assemblies 330, 340, and 350, respectively to the wellhead 60 via flowlines 331, 341, and 351, respectively.

In an embodiment, communicating fluid to a downhole portion of the subterranean formation 1800 may comprise communicating the WS fluid from the wellhead 60 to a depth within the wellbore and introducing the WS fluid into the subterranean formation for the performance of a given wellbore servicing operation. As explained above, the WS fluid may be introduced into the subterranean formation or a portion thereof via a suitable downhole wellbore servicing apparatus which may comprise various combinations of jets, nozzles, ports, windows, etc.

In an embodiment, the presently disclosed methods, systems, and apparatuses may present one or more advantages to an operator.

In an embodiment a wellbore servicing system, such as wellbore servicing systems 10A and/or 10B, may be capable of communicating a WS fluid to the wellbore at a high pressure and, simultaneously, at a high pumping rate at the recommended velocity (e.g., about 35 ft./sec). For example, in an embodiment, a wellbore servicing system, such as wellbore servicing systems 10A and/or 10B, may be capable of communicating a WS fluid at about 15,000 p.s.i. simultaneous with a pumping rate of about 136 BPM. In another embodiment a wellbore servicing system, such as wellbore servicing systems 10A and/or 10B, may be capable of communicating a WS fluid at about 10,000 p.s.i. simultaneous with a pumping rate of about 160 BPM. For example, employing an HPHP manifold like HPHP manifold 300 may allow for a greater total pumping rate without necessarily increasing the diameter of the manifold (which might result in an attendant drop in pressure) by communicating fluid via manifold outflow assemblies located toward opposite ends of the manifold (e.g., such as the first manifold outflow assembly 330 and the second manifold outflow assembly 340, illustrated in FIG. 4A-4C).

In another embodiment, a wellbore servicing system, such as wellbore servicing systems 10A and/or 10B, may be utilized in multiple modes. For example, as discussed above the WSMT 100 may be utilized in at least one of a split-flow mode or a boosted high-rate mode. As such, the variability and versatility of such a system or trailer may be advantageous to an operator in that a single system or apparatus may be employed to achieve differing servicing parameters. Also discussed above, the WSMT 100 may be configured to bypass various components of a wellbore servicing system, such as wellbore servicing systems 10A and/or 10B, where such a component becomes inoperable. The ability to so-configure the WSMT 100 may be advantageous to an operator in that, should a wellbore servicing system component become inoperable, the operator will not be forced to cease the servicing operation, thereby avoiding potential costs and lost time.

In another embodiment, a wellbore servicing system, such as wellbore servicing systems 10A and/or 10B, may reduce wear and/or damage to one or more components of such a servicing system. For example, in an embodiment where the WSMT 100 operates in split-flow mode, by communicating the first servicing fluid component (e.g., the concentrated slurry) via a first route of fluid communication (as explained above) and the second servicing fluid component (e.g., water) via a second route of fluid communication (also explained above), a portion of the components of the wellbore servicing system may only communicate water and/or another non-erosive fluid (for example, liquid carbon dioxide) and will not communicate the concentrated slurry, which may damage, degrade, erode, or corrode such components.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

What is claimed is:

1. A method of servicing a subterranean formation with a servicing fluid, the method comprising:
providing a first component of the servicing fluid to a first high-pressure pump at a first pressure;
providing a second component of the servicing fluid to a second high-pressure pump at a second pressure;
increasing the pressure of the first component of the servicing fluid at the first high-pressure pump to a third pressure, wherein the third pressure is greater than the first pressure;
increasing the pressure of the second component of the servicing fluid at the second high-pressure pump to a fourth pressure, wherein the fourth pressure is greater than the second pressure;
communicating the first component of the servicing fluid to a high-pressure manifold;
communicating the second component of the servicing fluid to the high-pressure manifold;
communicating the first component of the servicing fluid from a first high-pressure manifold outlet to a wellhead located at a wellbore;
communicating the second component of the servicing fluid from a second high-pressure manifold outlet to the wellhead; and
mixing the first component of the servicing fluid and the second component of the servicing fluid at the wellhead to form the servicing fluid.

2. The method of claim 1, wherein the servicing fluid comprises a fracturing fluid.

3. The method of claim 1, wherein the first component of the servicing fluid comprises a concentrated slurry.

4. The method of claim 3, wherein the concentrated slurry comprises a concentrated proppant-laden slurry.

5. The method of claim 1, wherein the second component of the servicing fluid comprises water or a non-erosive wellbore servicing fluid.

6. The method of claim 1, wherein providing the second component of the servicing fluid to the second high-pressure pump at a second pressure comprises;
providing a storage vessel containing the second component of the servicing fluid;
communicating the second component of the servicing fluid from the storage vessel to a boost pump; and
pressurizing the second component of the servicing fluid at the boost pump to about equal to the second pressure.

7. The method of claim 1, wherein the first high-pressure manifold outlet and the second high-pressure manifold outlet are located toward opposite ends of the manifold.

8. The method of claim 1, wherein the high-pressure manifold comprises a portion having substantially no fluid flow.

9. The method of claim 6, wherein the manifold and the boost pump are commonly located on a wellbore servicing trailer.

10. The method of claim 1, wherein the pressure of the servicing fluid at the wellhead is at least 10,000 p.s.i.

11. The method of claim 1, wherein the total pumping rate from the manifold is at least 86 barrels per minute (BPM).

12. A method of servicing a subterranean formation with a servicing fluid comprising:
providing a first component of the servicing fluid;
providing a second component of the servicing fluid;
increasing the pressure of the first component of the servicing fluid;
increasing the pressure of the second component of the servicing fluid;
communicating the first component of the servicing fluid via a first route of fluid communication;
communicating the second component of the servicing fluid to the via a second route of fluid communication, wherein the first route of fluid communication is in fluid communication with the second route of fluid communication;
mixing the first component of the servicing fluid and the second component of the servicing fluid at a wellhead to form the servicing fluid; and
communicating the servicing fluid into the subterranean formation at a pressure of at least 10,000 p.s.i. and at a total pumping rate of at least 86 BPM.

13. A system for servicing a subterranean formation with a servicing fluid comprising:
a wellbore servicing trailer comprising a high-pressure manifold comprising a first outlet and a second outlet, wherein the first outlet and the second outlet are located toward opposite ends of the manifold;
a first high-pressure pump;
a second high-pressure pump;
a wellhead;
a first component of the servicing fluid, wherein the first component of the servicing fluid is pressurized at the first high-pressure pump, communicated from the first high-pressure pump to the manifold, and communicated from the manifold to the wellhead via the first outlet; and
a second component of the servicing fluid, wherein the second component of the servicing fluid is pressurized at the second high-pressure pump, communicated from the second high-pressure pump to the manifold, communicated from the manifold to the wellhead via the second outlet, and mixed with the first component of the servicing fluid at the wellhead to form a servicing fluid.

14. The system of claim 13, wherein the servicing fluid comprises a fracturing fluid.

15. The system of claim 13, wherein the first component of the servicing fluid comprises a concentrated slurry.

16. The system of claim 13, wherein the second component of the servicing fluid comprises water or a non-erosive wellbore servicing fluid.

17. The system of claim 13, wherein the wellbore servicing trailer further comprises a boost pump.

18. The system of claim 13, wherein substantially no fluid flows through a portion of the manifold.

19. The system of claim 13, wherein the total pumping rate from the manifold is at least 86 BPM.

20. The system of claim 13, wherein the servicing fluid is communicated to the subterranean formation.
